(19) United States
(12) Patent Application Publication
(10) Pub. No.: US 2026/0032425 A1
(43) Pub. Date: Jan. 29, 2026

(54) SYSTEM INFORMATION ACQUISITION BY ENERGY HARVESTING DEVICES

(71) Applicant: QUALCOMM Incorporated, San Diego, CA (US)

(72) Inventors: Linhai HE, San Diego, CA (US); Ahmed ELSHAFIE, San Diego, CA (US); Yuchul KIM, San Diego, CA (US); Zhikun WU, Beijing (CN)

(21) Appl. No.: 18/881,446

(22) PCT Filed: Sep. 1, 2022
(86) PCT No.: PCT/CN2022/116451

§ 371 Date: Jan. 6, 2025

(51) Int. Cl. H04W 8/22; H04L 5/00; H04W 74/0833

(52) U.S. Cl. CPC H04W 8/22; H04L 5/0044; H04W 74/0833

(57) ABSTRACT

Various aspects of the present disclosure generally relate to wireless communication. In some aspects. a user equipment (UE) may receive. from a network node. a first system information block (SIB) that indicates an energy harvesting capability class supported by the network node. The UE may receive. from the network node and based at least in part on receiving the first SIB and the UE being associated with the energy harvesting capability class. a second SIB having one or more SIB characteristics that are based at least in part on the energy harvesting capability class. Numerous other aspects are described.

### FIELD OF THE DISCLOSURE

Aspects of the present disclosure generally relate to wireless communication and to techniques and apparatuses for system information acquisition by energy harvesting devices.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a network node, a first system information block (SIB) that indicates an energy harvesting (EH) capability class supported by the network node. The method may include receiving, from the network node and based at least in part on receiving the first SIB and the UE being associated with the EH capability class, a second SIB having one or more SIB characteristics that are based at least in part on the EH capability class.

Some aspects described herein relate to a method of wireless communication performed by a network node. The method may include transmitting a first SIB that indicates an EH capability class supported by the network node. The method may include transmitting a second SIB having one or more SIB characteristics that are based at least in part on the EH capability class.

Some aspects described herein relate to a UE for wireless communication. The user equipment may include a memory and one or more processors coupled to the memory. The one or more processors may be configured to receive, from a network node, a first SIB that indicates an EH capability class supported by the network node. The one or more processors may be configured to receive, from the network node and based at least in part on receiving the first SIB and the UE being associated with the EH capability class, a second SIB having one or more SIB characteristics that are based at least in part on the EH capability class.

Some aspects described herein relate to a network node for wireless communication. The network node may include a memory and one or more processors coupled to the memory. The one or more processors may be configured to transmit a first SIB that indicates an EH capability class supported by the network node. The one or more processors may be configured to transmit a second SIB having one or more SIB characteristics that are based at least in part on the EH capability class.

Some aspects described herein relate to a non-transitory computer-readable medium that stores a set of instructions for wireless communication by a UE. The set of instructions, when executed by one or more processors of the UE, may cause the UE to receive, from a network node, a first SIB that indicates an EH capability class supported by the network node. The set of instructions, when executed by one or more processors of the UE, may cause the UE to receive, from the network node and based at least in part on receiving the first SIB and the UE being associated with the EH capability class, a second SIB having one or more SIB characteristics that are based at least in part on the EH capability class.

Some aspects described herein relate to a non-transitory computer-readable medium that stores a set of instructions for wireless communication by a network node. The set of instructions, when executed by one or more processors of the network node, may cause the network node to transmit a first SIB that indicates an EH capability class supported by the network node. The set of instructions, when executed by one or more processors of the network node, may cause the network node to transmit a second SIB having one or more SIB characteristics that are based at least in part on the EH capability class.

Some aspects described herein relate to an apparatus for wireless communication. The apparatus may include means for receiving, from a network node, a first SIB that indicates an EH capability class supported by the network node. The apparatus may include means for receiving, from the network node and based at least in part on receiving the first SIB and the UE being associated with the EH capability class, a second SIB having one or more SIB characteristics that are based at least in part on the EH capability class.

Some aspects described herein relate to an apparatus for wireless communication. The apparatus may include means for transmitting a first SIB that indicates an EH capability class supported by the network node. The apparatus may include means for transmitting a second SIB having one or more SIB characteristics that are based at least in part on the EH capability class.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of system information transmission and acquisition, in accordance with the present disclosure.

FIG. 5 is a diagram illustrating an example of radio frequency (RF) energy harvesting, in accordance with the present disclosure.

FIG. 6 is a diagram of an example associated with system information acquisition by energy harvesting devices, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

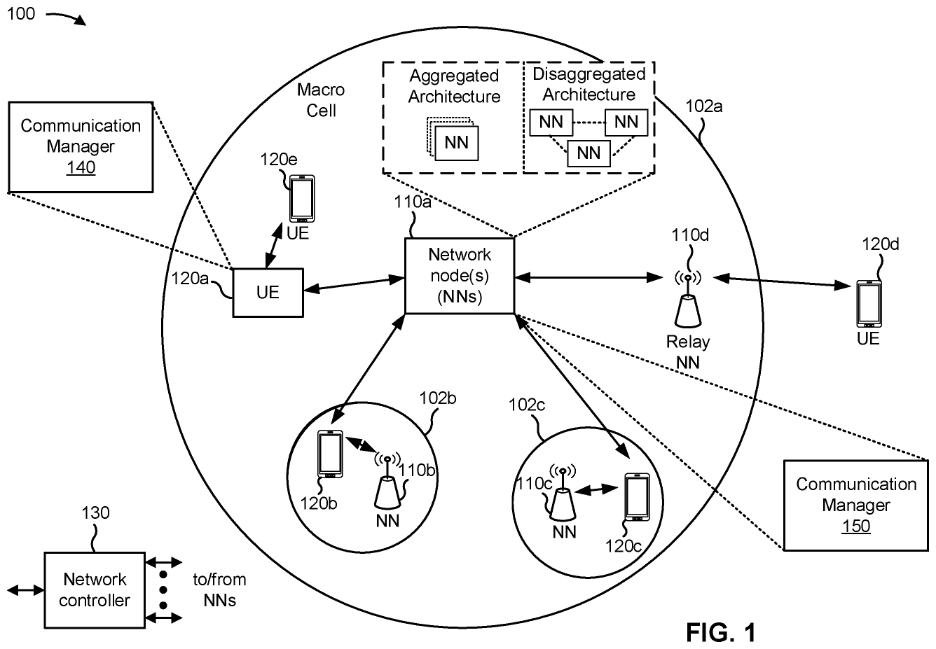

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network node, a first system information block (SIB) that indicates an EH capability class (also referred to as an EH class) supported by the network node; and receive, from the network node and based at least in part on receiving the first SIB and the UE being associated with the EH class, a second SIB having one or more SIB characteristics that are based at least in part on the EH class. Additionally, or alternatively, the communication manager 140 may perform one or more other operations described herein.

In some aspects, the network node may include a communication manager 150. As described in more detail elsewhere herein, the communication manager 150 may transmit a first SIB that indicates an EH class supported by the network node; and transmit a second SIB having one or more SIB characteristics that are based at least in part on the EH class. Additionally, or alternatively, the communication manager 150 may perform one or more other operations described herein.

As indicated above, FIG. 1 is provided as an example. Other examples may differ from what is described with regard to FIG. 1.

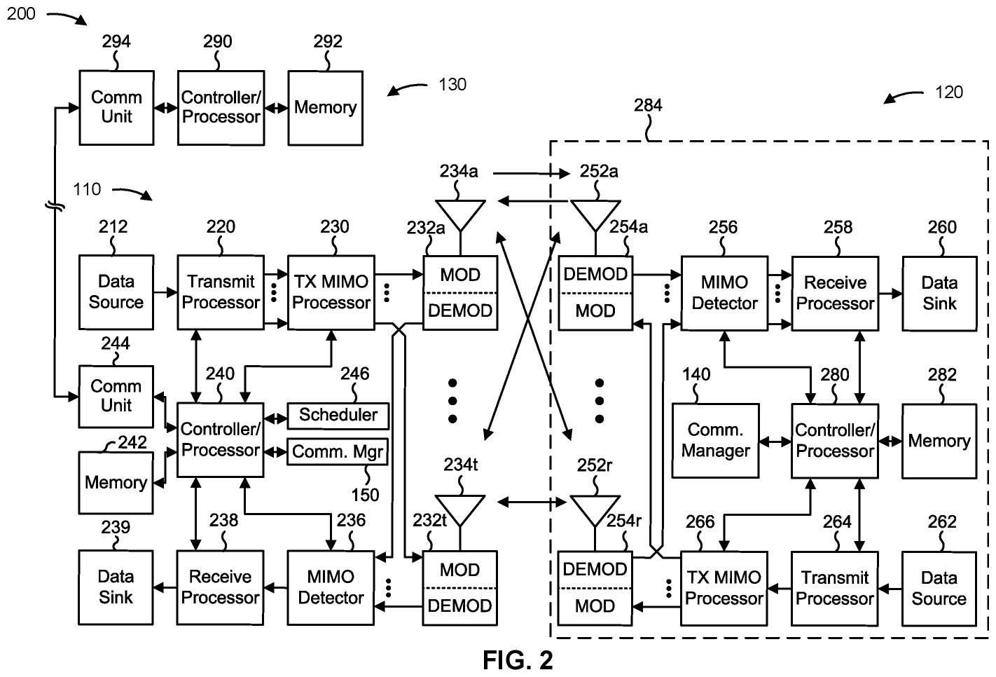

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

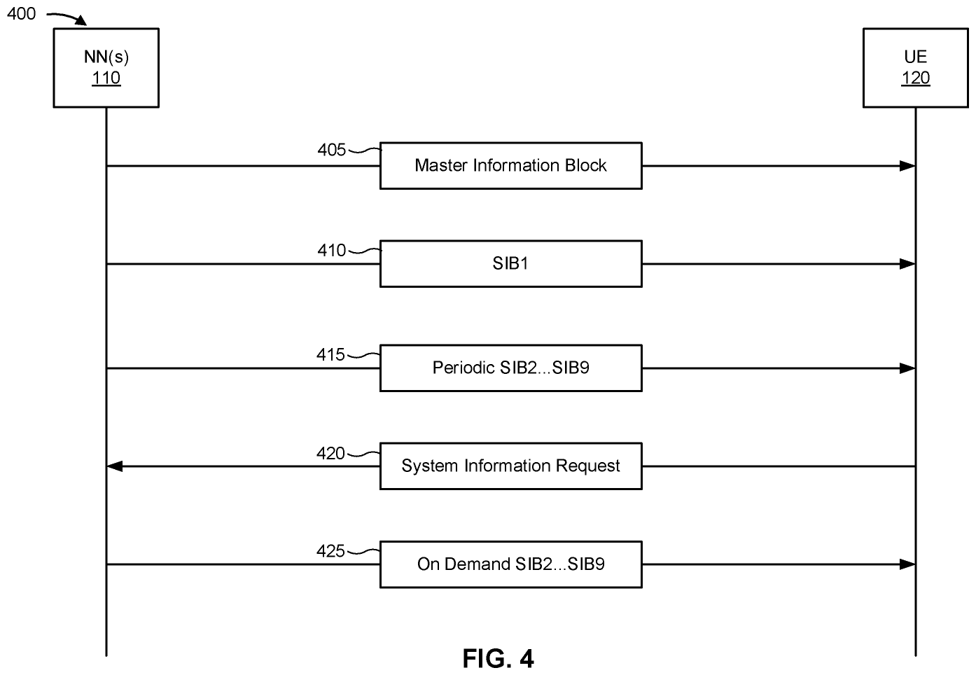

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-10).

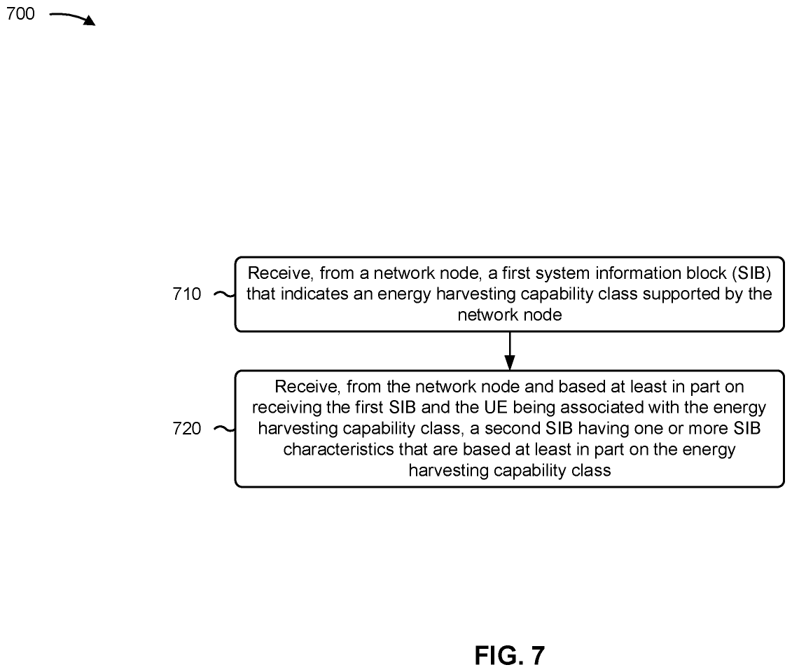

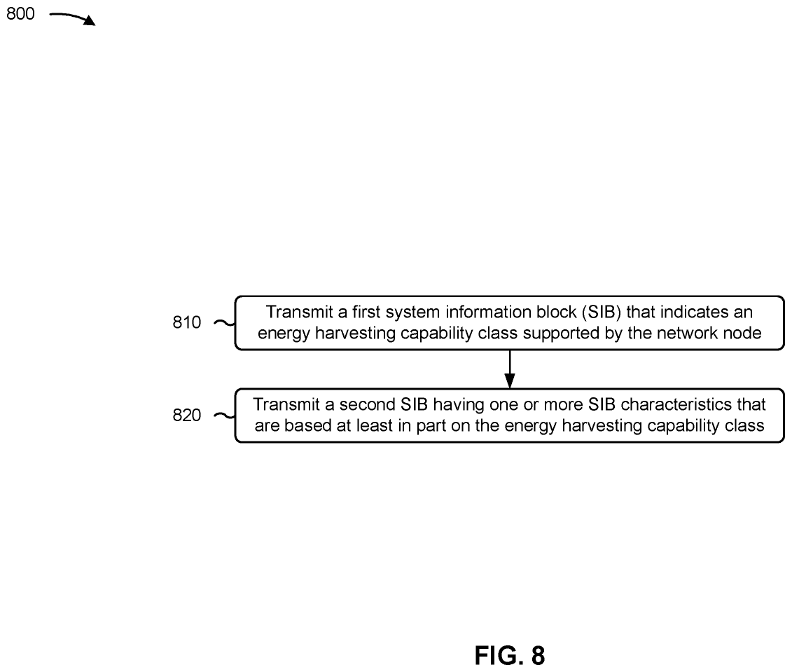

The controller/processor 240 of the network node 110, the controller/processor 280 of the UE 120, and/or any other component(s) of FIG. 2 may perform one or more techniques associated with system information acquisition by EH devices, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE includes means for receiving, from a network node, a first SIB that indicates an EH class supported by the network node; and/or means for receiving, from the network node and based at least in part on receiving the first SIB and the UE being associated with the EH class, a second SIB having one or more SIB characteristics that are based at least in part on the EH class. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting a first SIB that indicates an EH class supported by the network node; and/or means for transmitting a second SIB having one or more SIB characteristics that are based at least in part on the EH class. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

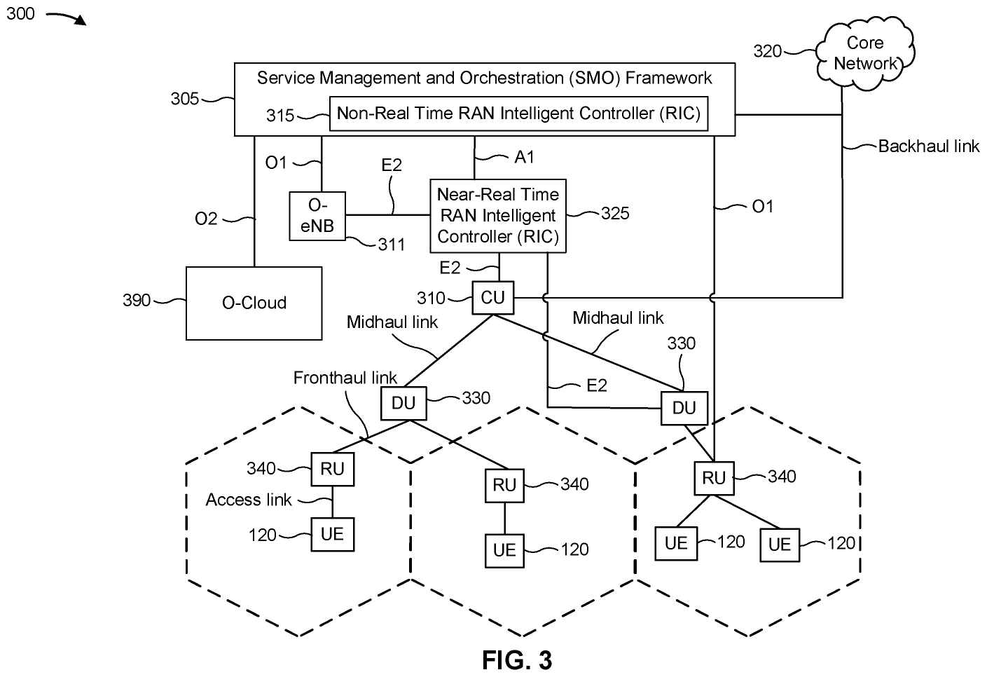

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

FIG. 4 is a diagram illustrating an example 400 of system information transmission and acquisition, in accordance with the present disclosure. As shown in FIG. 4, a network node 110 and a UE 120 may communicate with one another. For example, the network node 110 may transmit system information to the UE 120 to enable communications between the UE 120 and a network accessed via the network node 110.

As shown by reference number 405, the network node may transmit, and the UE may receive, a master information block (MIB). The network node transmits the MIB as a broadcast over a physical broadcast channel (PBCH). The network node 110 may transmit the MIB periodically, such that the MIB may be periodically received by UEs and used, for example, for cell selection. The MIB may include information regarding a control resource set (CORESET) and physical downlink control channel (PDCCH) search space for receiving and decoding SIBs, such as SIB1.

As shown by reference number 410, the network node may transmit, and the UE may receive, SIB1. Collectively, the MIB and SIB1 may be referred to as minimum system information (MSI), and SIB1 alone may be referred to as remaining minimum system information (RMSI). The network node may transmit the SIB1 via PDCCH communication. As noted herein, the MIB includes the parameters for the UE to decode the SIB1, which includes cell-specific information specifying parameters for the UE to access the corresponding cell. SIB1 also includes information indicating the availability and scheduling of other SIBs (e.g., SIBs 2-9), such as the periodicity and system information window size, among other examples. The SIB1 may also indicate whether the other SIBs are provided periodically and/or on-demand. If other SIBs are available on-demand, the SIB1 may also include information enabling the UE to perform a system information request for the on-demand SIBs.

As shown by reference number 415, the network node 110 may periodically transmit, and the UE 120 may periodically receive, other SIBs, such as SIBs 1-9 (e.g., in accordance with the information provided in the SIB1). The other SIBs include system information other than MSI, which may be used by the network node 110 and UE 120 for communications. For example, SIB2, SIB3, SIB4, and SIB5 may include information for various types of cell-reselection processes, SIB6, SIB7, and SIB8 may include information associated with various warning and/or alert notifications, and SIB9may include timing information. The network node may transmit the other SIBs via physical downlink shared channel (PDSCH) communications. As noted herein, the network node may transmit none, some, or all of the other SIBs periodically.

As shown by reference number 420, the UE 120 may transmit, and the network node 110 may receive, a system information request. For example, in a situation where the SIB1 indicates that the network node 110 is capable of transmitting one or more of the other SIBs on-demand, the UE may use the information included in SIB1 to request one or more of the other SIBs.

As shown by reference number 425, the network node 110 may transmit, and the UE 120 may receive one or more of the other SIBs based on the system information request. The on-demand SIBs may include the same information as the corresponding periodic SIBs, though they may be requested and transmitted on-demand.

As indicated above, FIG. 4 is provided as an example. Other examples may differ from what is described with respect to FIG. 4.

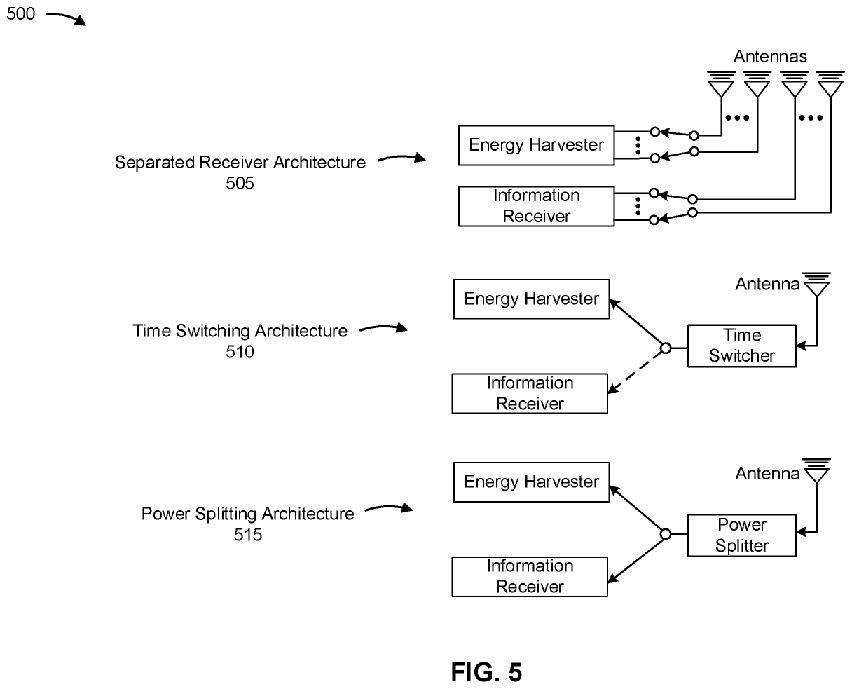

FIG. 5 is a diagram illustrating an example 500 of radio frequency (RF) energy harvesting, in accordance with the present disclosure. As shown in FIG. 5, an RF receiver (e.g., a UE 120) may receive signals (e.g., radio signals carried on radio waves) from an RF transmitter (e.g., a network node 110 or UE 120) and convert electromagnetic energy of the signals (e.g., using a rectenna comprising a dipole antenna with an RF diode) into direct current electricity for use by the RF receiver.

As shown by reference number 505, in some aspects, the RF receiver may use a separated receiver architecture, where a first set of antennas is configured to harvest energy, and a second set of antennas is configured to receive data. In this situation, each set of antennas may be separately configured to receive signals at certain times, frequencies, and/or via one or more particular beams, such that all signals received by the first set of antennas are harvested for energy, and all signals received by the second set of antennas are processed to receive information.

As shown by reference number 510, in some aspects, the RF receiver may use a time-switching architecture to harvest energy. The time switching architecture may use one or more antennas to receive signals, and whether the signals are harvested for energy or processed to receive information depends on the time at which the signals are received. For example, one or more first time slots may be time slots during which received signals are sent to one or more EH components to harvest energy, and one or more second time slots may be time slots during which received signals are processed and decoded to receive information. In some aspects, the time slots may be pre-configured (e.g., by the RF receiver, the RF transmitter, or another device).

As shown by reference number 515, in some aspects, the RF receiver may use a power splitting architecture to harvest energy. The power splitting architecture may use one or more antennas to receive signals, and the signals are handled by one or both of the EH and/or information receiving components according to an EH rate. For example, the RF receiver may be configured to use a first portion of received signals for EH and the remaining received signals for information receiving. In some aspects, the EH rate may be pre-configured (e.g., by the RF receiver, the RF transmitter, or another device).

Energy harvested by the RF receiver may be used and/or stored for later use. For example, in some aspects, the RF receiver may be powered directly by the harvested energy. In some aspects, the RF receiver may use an energy storage device, such as a battery, capacitor, and/or supercapacitor, to gather and store harvested energy for immediate and/or later use.

As indicated above, FIG. 5 is provided as an example. Other examples may differ from what is described with respect to FIG. 5. In some aspects, a UE (e.g., a UE 120) may harvest energy in other ways, alone or in combination with RF energy harvesting. For example, solar energy harvesting (e.g., using solar panels to convert sunlight to energy), thermal energy harvesting (e.g., using a thermoelectric generator to convert heat to energy), and/or mechanical energy harvesting (e.g., using electromagnetic induction to convert vibrations or other physical movement into energy), among other examples, may be used by a UE to harvest energy for storage and/or for actively powering the UE.

Some EH UEs are capable of communicating (e.g., with other UEs and/or network nodes), but require power to transmit and/or receive communications. A variety of different types of EH UEs exist with a range of capabilities that may depend, for example, on how much energy the UEs are capable of storing, how quickly the UEs can charge energy, and how much energy the UEs use to perform various actions, among other examples. Due to the nature of EH, some EH UEs may not have the power available to communicate in the same manner as other UEs that are not reliant on EH, which may cause communications with EH UEs to be intermittent. For example, larger communications (e.g., larger transport blocks) may require more energy to receive and process than smaller communications (e.g., smaller transport blocks), and communications that take more time may require more energy to receive and process than communications that are relatively short. This may lead to dropped communications with EH UEs, or even lead to some UEs being incapable of processing certain types of communications that exceed the EH UE's capabilities.

The limited capabilities of some EH UEs may also be problematic when operating in an idle mode, because an idle UE and network have not yet established any connection yet to coordinate operations. In this situation, predefined procedures, such duty cycling transmissions, can enable the exchange of system information to facilitate establishing communications between the network and the UE, but this may consume significant network resources and lead to lower performance for some EH UEs that might be more capable than other EH UEs. Problems, including delays, associated with the delivery of system information to UEs may negatively impact how quickly and efficiently the UEs can establish communications with a network, and may prevent some UEs from being able to receive the system information entirely.

Some techniques and apparatuses described herein enable EH UEs to acquire system information in a manner that accounts for the different capabilities of the EH UEs. For example, a network node may transmit a first SIB that is specific to EH devices (e.g., a SIB-EH). The SIB-EH may indicate which EH class(es) are supported by the network node, such that an EH UE may receive further system information in a SIB that has one or more characteristics based on the EH class of the UE. This may enable the network node to transmit different SIBs for UEs associated with different EH classes, and enables the UEs to receive and process SIBs that are tailored for the EH class of the UE. As a result, UEs are able to acquire system information in a manner that accounts for the impact that EH has on the capabilities of the UEs. In this way, network nodes and EH UEs may more efficiently communicate system information (e.g., relative to relying on legacy SIBs and/or duty cycling transmissions), better support for less capable EH UEs to be able to acquire system information, and fewer dropped communications between network nodes and EH UEs, among other examples.

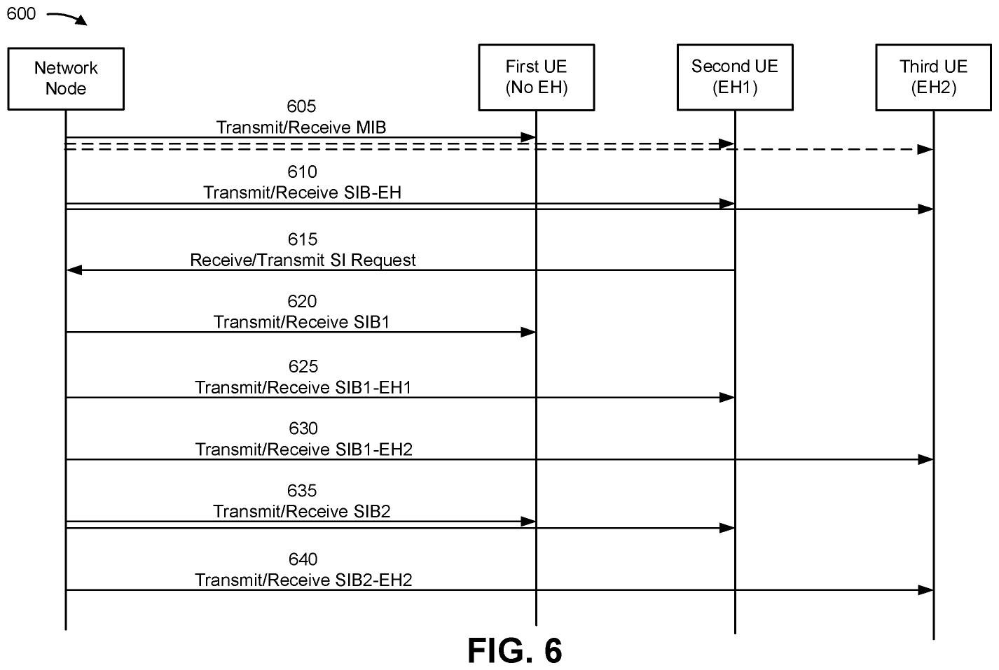

FIG. 6 is a diagram of an example 600 associated with system information acquisition by EH devices, in accordance with the present disclosure. As shown in FIG. 6, a network node (e.g., network node 110) may communicate with one or more UEs (e.g., first, second, and third UEs 120). In some aspects, the UEs and network node may be part of a wireless network (e.g., wireless network 100). The UEs may be operating in an idle mode (e.g., not connected and/or not yet in communication with the network node). The example UEs include a first UE that is not associated with EH (e.g., UE (No EH)), a second UE that is associated with a first EH class (e.g., UE (EH1)), and a third UE that is associated with a second EH class (e.g., UE (EH2)).

As shown by reference number 605, the network node may transmit, and one or more of the UEs may receive, a MIB. For example, as described herein, the network node may broadcast the MIB via PBCH, and the MIB may be received by one or more of the UEs. The MIB may include information associated with one or more parameters that may be used by the UEs to receive SIB1 and/or SIB-EH. While this example depicts one MIB being received by each example UE, and therefore including parameters for receiving both SIB1 (e.g., for the first UE) and SIB-EH (e.g., for the second and third UEs), in some aspects, the SIB-EH may be associated with a separate MIB. In this situation, the MIB received by the first UE would be different from the MIB received by the second and third UEs. In some aspects, when multiple MIBs are used, the UEs may be configured to monitor for a particular MIB that corresponds to the type of UE. For example, the first UE may be configured to only monitor for a first MIB that carries information for receiving the SIB, while the second and third UEs may be configured to only monitor for a second MIB that carries information for receiving the SIB-EH. Any number of separate MIBs may be configured (e.g., for different EH classes) and the UEs may be configured to monitor for any number of MIBs (e.g., not just those associated with the UE's EH class).

As shown by reference number 610, the network node may transmit, and one or more of the UEs may receive, a SIB-EH. In this example, the first UE, which is not associated with an EH class, does not receive the SIB-EH, as it may instead receive SIB1 (e.g., as described herein with reference to 620). The second and third UEs both receive the SIB-EH based at least in part on receiving the corresponding MIB. For example, the second and third UEs may decode the MIB to obtain one or more parameters for decoding the SIB-EH and then use the parameters to decode the SIB-EH. In some aspects, the SIB-EH is received via PDCCH, and the resources carrying the SIB-EH are indicated by the corresponding MIB. While the example depicts different UEs of different EH classes receiving the same SIB-EH, in some aspects, a different SIB-EH may be transmitted for different EH classes.

In some aspects, the SIB-EH indicates one or more EH classes that are supported by the network node. For example, the network node may be configured to communicate with UEs associated with multiple different EH classes. In this situation, the SIB-EH may indicate each of the supported EH classes (e.g., at least EH1 and EH2, in the example 600).

In some aspects, the EH classes may be pre-configured and/or defined by a specification. In some aspects, the EH classes may be based on the capabilities or characteristics of the EH UEs. For example, EH classes may be defined based on a maximum number of communications (e.g., transmissions and/or receptions) that the UE is capable of performing with a full charge, a charging rate of the UE, and/or a duration of time (e.g., an average duration of time) to acquire a full charge.

In some aspects, different EH classes may be associated with different SIB characteristics that may enable UEs of different EH classes to acquire system information in different ways. For example, SIB characteristics may indicate, for an EH-specific SIB, whether the EH-specific SIB is to be transmitted via one or multiple transport blocks (TBs). While multiple TBs may take more time to transmit, some large TBs may be too large for some EH UEs to reliably receive, and breaking a TB into multiple smaller TBs may provide UEs with time to harvest energy between transmissions. Another example SIB characteristic may include a parameter that is based at least in part on the EH class. For example, some EH-specific SIBs may include certain parameters that are only relevant to the corresponding EH class, such as a parameter to indicate how many PDSCH occasions an EH UE is capable of monitoring before recharging. As another example, a SIB characteristic may include, for a parameter, a particular parameter value that is based at least in part on the EH class. For example, a parameter indicating a random access channel (RACH) interval, a parameter indicating a maximum TB size, and/or a parameter indicating a maximum number of PDSCH occasions capable of being monitored on a full charge, among other examples, may be different for different EH classes.

In some aspects, the SIB-EH may indicate one or more resources via which an EH-specific SIB1 (e.g., SIB1-EH1 and/or SIB1-EH2) is to be transmitted and/or one or more parameters associated with receiving the EH-specific SIB1. For example, the SIB-EH may indicate PDSCH resources for receiving SIB1-EH1 and/or SIB1-EH2.

In some aspects, the SIB-EH may indicate, for an EH class, which SIBs may be available on-demand. For example, in addition to, or alternatively to, periodically transmitting each EH-specific SIB, the network node may be capable of transmitting the EH-specific SIBs on-demand. In this situation, the SIB-EH may include information that enables a UE to request one or more of the SIBs that are available on-demand, such as how the request is to be transmitted for any given EH-specific SIB. In some aspects, any or all of the EH-specific SIBs may be available on-demand. In some aspects, EH-specific SIBs are available on demand may also depend on the EH class (e.g., on-demand SIBs may be supported by some EH classes, but not others).

In some aspects, the EH classes supported by the network node may be based at least in part on wireless conditions associated with the network node (e.g., cell loading). For example, if the cellular load on a network node is relatively high, the network node may support fewer EH classes than when the cellular load is relatively low. The network node may dynamically change which EH classes are supported as conditions change, and any changes may be reflected in the SIB-EH.

As shown by reference number 615, at least one of the UEs may transmit, and the network node may receive, a system information request. For example, the second UE, based at least in part on the SIB-EH indicating that another SIB (e.g., SIB1-EH1) is available on-demand, may transmit the system information request (e.g., using information included in the SIB-EH). In some aspects, the system information request may indicate that the second UE is requesting SIB1-EH1. In some aspects, the system information request may include a request for any number of SIBs, EH-specific and/or otherwise. In some aspects, multiple system information requests may be transmitted (e.g., one request for each of any number of on-demand SIBs, EH-specific and/or otherwise).

In some aspects, the system information request may be included in a PRACH message (e.g., a random access message, or Msg1). For example, the request may be included in a preamble that is associated with the corresponding EH class. In some aspects, the system information request may be included in a physical uplink shared channel (PUSCH) message associated with a RACH procedure (e.g., a Msg3). For example, the system information request may be indicated by a medium access control (MAC) control element included in the PUSCH message. In this situation, the MAC control element may indicate the requested SIB (e.g., SIB1-EH1) and the EH class of the first UE (e.g., EH1). In this way, the network node may handle an EH-specific system information request while also performing a RACH procedure.

As shown by reference number 620, the network node may transmit, and at least one UE (e.g., the first UE) may receive, a SIB1. For example, the SIB1 may be a periodic transmission in this example, as the first UE did not request the SIB1. In this example, the SIB1 is not EH-specific, as the network node is capable of supporting different types of SIBs, EH-specific and/or otherwise. As described herein, the SIB1 includes RMSI, which includes cell-specific information that enables the first UE to communicate with the network node and access the corresponding cell. The SIB1 may also include information indicating the availability and scheduling of other SIBs and which other SIBs are available on-demand.

As shown by reference number 625, the network node may transmit, and at least one UE (e.g., the second UE) may receive, an EH-specific SIB1 (e.g., SIB1-EH1) that has one or more characteristics that are based at least in part on the EH class of the second UE. For example, the SIB1-EH1 may be transported in multiple TBs, and/or may have one or more parameters specific to the corresponding EH class (e.g., EH1), as described herein. In this example, the SIB1-EH1 may be transmitted to the second UE on-demand (e.g., based at least in part on the network node receiving the system information request, as described herein). The second UE may be monitoring for the SIB1-EH1 based at least in part on the information included SIB-EH and the second UE being included in an EH class that corresponds to the SIB1-EH1. As with SIB1, SIB1-EH1 may include RMSI, information indicating the availability and scheduling of other SIBs (EH-specific or otherwise), and information indicating which other SIBs are available on-demand, among other examples.

As shown by reference number 630, the network node may transmit, and at least one UE (e.g., the third UE) may receive, another EH-specific SIB1 (e.g., SIB1-EH2) that has one or more characteristics that are based at least in part on the EH class of the third UE. In this example, the SIB1-EH2 may a periodic transmission (e.g., the schedule being identified by the SIB-EH and not being transmitted in response to a system information request). The third UE may be monitoring for the SIB1-EH2 based at least in part on the information included SIB-EH and the third UE being included in an EH class that corresponds to the SIB1-EH2. As with SIB1 and SIB1-EH1, SIB1-EH2 may include RMSI, information indicating the availability and scheduling of other SIBs (EH-specific or otherwise), and information indicating which other SIBs are available on-demand, among other examples.

As shown by reference number 635, the network node may transmit, and at least one UE (e.g., the first UE and the second UE) may receive, another SIB that is not EH-specific. In this example, SIB2 is not EH-specific but is received by both the first UE and the second UE. In this situation, the second UE may be included in an EH class that is capable of receiving SIB2 without altering one or more SIB characteristics of the SIB2. Accordingly, the network node may forgo transmission of a SIB2 that is specific to the EH class (e.g., EH1), which may conserve resources while enabling the second UE to efficiently receive the system information included in SIB2. For example, the SIB2 may be transmitted in a single TB. In this example, while no system information request is shown for SIB2, as with the other SIBs, SIB2 may be transmitted periodically or on-demand.

As shown by reference number 640, the network node may transmit, and at least one UE (e.g., the third UE) may receive, another EH-specific SIB (e.g., SIB2-EH2). In this example, SIB2-EH2 is EH-specific, and may be transmitted and/or received in a manner similar to SIB1-EH2, described herein. In this situation, the SIB2-EH2 may have one or more characteristics that differ from SIB2, to enable the third UE to acquire the system information obtained within.

In some aspects, the network node may be configured with information identifying multiple EH-specific SIB sets for transmission to EH UEs, such as an EH-specific SIB set for each EH class. In this situation, some EH-specific SIBs may be included in more than one EH-specific SIB set (e.g., if multiple EH classes are capable of receiving the same EH-specific SIB), and some EH-specific SIB sets may include one or more SIBs that are not EH-specific. For example, an EH UE with relatively high capabilities (e.g., for charging, energy storage, and/or communication processing) may be capable of receiving some SIBs that are not EH-specific, while an EH UE with relatively low capabilities may need most or even all SIBs to be EH-specific.

By transmitting different SIBs for UEs associated with different EH capabilities, UEs are able to acquire system information in a manner that accounts for the impact that EH has on the capabilities of the UEs. In this way, network nodes and EH UEs may more efficiently communicate system information (e.g., relative to relying on legacy SIBs and/or duty cycling transmissions), better support for less capable EH UEs to be able to acquire system information, and fewer dropped communications between network nodes and EH UEs, among other examples.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with system information acquisition.

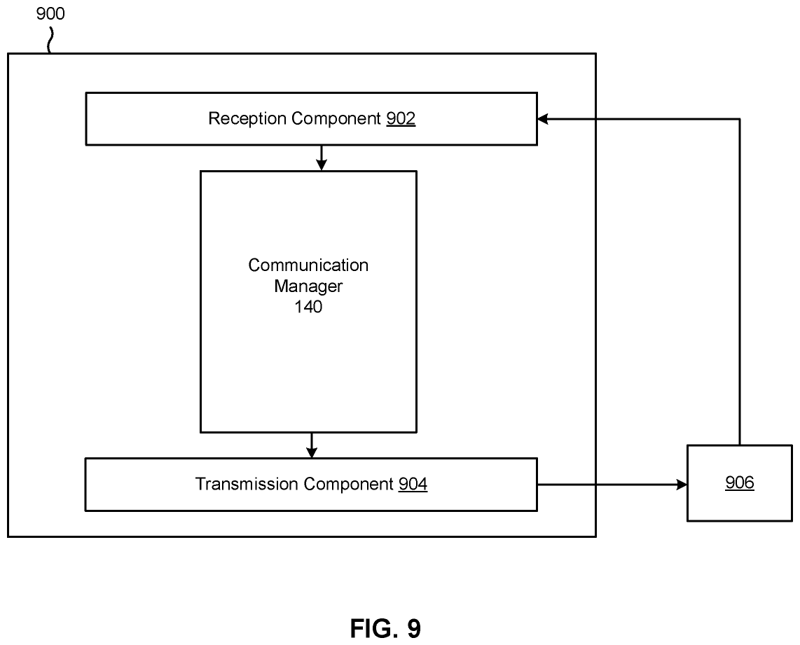

As shown in FIG. 7, in some aspects, process 700 may include receiving, from a network node, a first SIB that indicates an EH class supported by the network node (block 710). For example, the UE (e.g., using communication manager 140 and/or reception component 902, depicted in FIG. 9) may receive, from a network node, a first SIB that indicates an EH class supported by the network node, as described above.

As further shown in FIG. 7, in some aspects, process 700 may include receiving, from the network node and based at least in part on receiving the first SIB and the UE being associated with the EH class, a second SIB having one or more SIB characteristics that are based at least in part on the EH class (block 720). For example, the UE (e.g., using communication manager 140 and/or reception component 902, depicted in FIG. 9) may receive, from the network node and based at least in part on receiving the first SIB and the UE being associated with the EH class, a second SIB having one or more SIB characteristics that are based at least in part on the EH class, as described above.

Process 700 may include additional aspects, such as any single aspect or any combination of aspects described below and/or in connection with one or more other processes described elsewhere herein.

In a first aspect, the one or more SIB characteristics comprise at least one of the second SIB is transmitted via a plurality of transport blocks, the second SIB includes a parameter that is based at least in part on the EH class, or the second SIB includes, for a parameter, a parameter value that is based at least in part on the EH class.

In a second aspect, alone or in combination with the first aspect, the first SIB indicates one or more resources via which the second SIB is to be transmitted.

In a third aspect, alone or in combination with one or more of the first and second aspects, the EH class is associated with at least one of a maximum number of communications with a full charge, a charging rate, or a duration to acquire the full charge.

In a fourth aspect, alone or in combination with one or more of the first through third aspects, the first SIB includes information identifying a plurality of different EH classes supported by the network node.

In a fifth aspect, alone or in combination with one or more of the first through fourth aspects, receiving the first SIB comprises receiving a PBCH communication that includes a MIB and the first SIB, decoding the MIB to obtain one or more parameters for decoding the first SIB, and decoding the first SIB.

In a sixth aspect, alone or in combination with one or more of the first through fifth aspects, receiving the second SIB comprises receiving the second SIB via a plurality of transport blocks.

In a seventh aspect, alone or in combination with one or more of the first through sixth aspects, process 700 includes receiving at least one other SIB in a single transport block.

In an eighth aspect, alone or in combination with one or more of the first through seventh aspects, the first SIB further indicates one or more resources in which one or more other SIBs are to be transmitted.

In a ninth aspect, alone or in combination with one or more of the first through eighth aspects, the first SIB further indicates that at least one of the second SIB, or at least one of the one or more other SIBs, are to be transmitted via a plurality of transport blocks.

In a tenth aspect, alone or in combination with one or more of the first through ninth aspects, the first SIB further indicates, for the EH class, which of a plurality of other SIBs are available on-demand.

In an eleventh aspect, alone or in combination with one or more of the first through tenth aspects, process 700 includes transmitting, to the network node, a request for the second SIB based at least in part on the first SIB indicating that the second SIB is available on-demand.

In a twelfth aspect, alone or in combination with one or more of the first through eleventh aspects, the request is included in a physical random access channel message.

In a thirteenth aspect, alone or in combination with one or more of the first through twelfth aspects, the request includes a preamble associated with the EH class.

In a fourteenth aspect, alone or in combination with one or more of the first through thirteenth aspects, the request is included in a PUSCH message associated with a random access procedure.

In a fifteenth aspect, alone or in combination with one or more of the first through fourteenth aspects, the request is indicated by a MAC control element included in the PUSCH message.

In a sixteenth aspect, alone or in combination with one or more of the first through fifteenth aspects, the MAC control element indicates the second SIB and the EH class.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with system information acquisition.

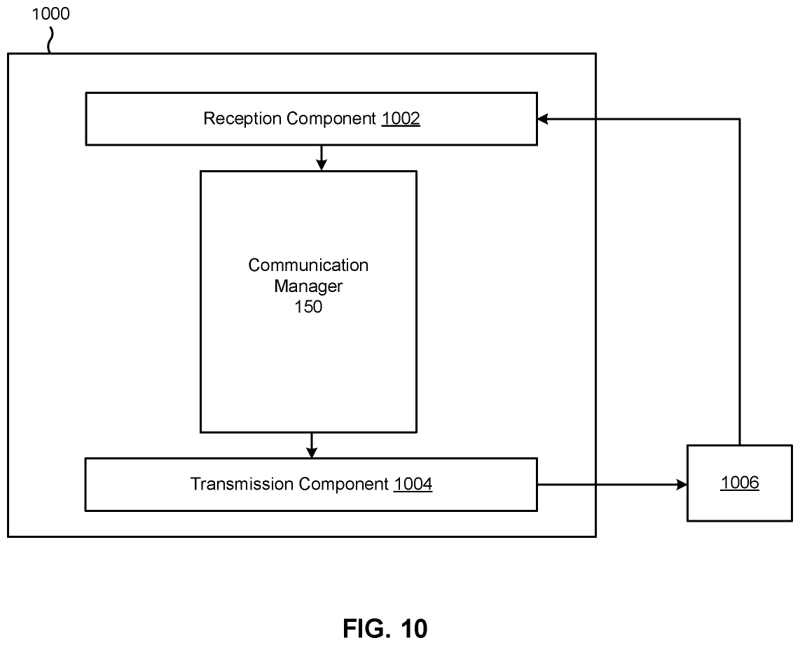

As shown in FIG. 8, in some aspects, process 800 may include transmitting a first SIB that indicates an EH class supported by the network node (block 810). For example, the network node (e.g., using communication manager 150 and/or transmission component 1004, depicted in FIG. 10) may transmit a first SIB that indicates an EH class supported by the network node, as described above.

As further shown in FIG. 8, in some aspects, process 800 may include transmitting a second SIB having one or more SIB characteristics that are based at least in part on the EH class (block 820). For example, the network node (e.g., using communication manager 150 and/or transmission component 1004, depicted in FIG. 10) may transmit a second SIB having one or more SIB characteristics that are based at least in part on the EH class, as described above.

Process 800 may include additional aspects, such as any single aspect or any combination of aspects described below and/or in connection with one or more other processes described elsewhere herein.

In a first aspect, the one or more SIB characteristics comprise at least one of the second SIB is transmitted via a plurality of transport blocks, the second SIB includes a parameter that is based at least in part on the EH class, or the second SIB includes, for a parameter, a parameter value that is based at least in part on the EH class.

In a second aspect, alone or in combination with the first aspect, the first SIB indicates one or more resources via which the second SIB is to be transmitted.

In a third aspect, alone or in combination with one or more of the first and second aspects, the EH class is associated with at least one of a maximum number of communications with a full charge, a charging rate, or a duration to acquire the full charge.

In a fourth aspect, alone or in combination with one or more of the first through third aspects, the first SIB includes information identifying a plurality of different EH classes supported by the network node.

In a fifth aspect, alone or in combination with one or more of the first through fourth aspects, transmitting the first SIB comprises transmitting a PBCH communication that includes a MIB and the first SIB.

In a sixth aspect, alone or in combination with one or more of the first through fifth aspects, transmitting the second SIB comprises transmitting the second SIB via a plurality of transport blocks.

In a seventh aspect, alone or in combination with one or more of the first through sixth aspects, the first SIB further indicates one or more resources in which one or more other SIBs are to be transmitted.

In an eighth aspect, alone or in combination with one or more of the first through seventh aspects, the first SIB further indicates that at least one of the second SIB, or at least one of the one or more other SIBs, are to be transmitted via a plurality of transport blocks.

In a ninth aspect, alone or in combination with one or more of the first through eighth aspects, the first SIB further indicates, for the EH class, which of a plurality of other SIBs are available on-demand.

In a tenth aspect, alone or in combination with one or more of the first through ninth aspects, process 800 includes receiving, from a UE, a request for the first SIB, and wherein transmitting the first SIB comprises transmitting the first SIB based at least in part on receiving the request.

In an eleventh aspect, alone or in combination with one or more of the first through tenth aspects, process 800 includes receiving, from a UE, a request for the second SIB, and wherein transmitting the second SIB comprises transmitting the second SIB based at least in part on receiving the request.

In a twelfth aspect, alone or in combination with one or more of the first through eleventh aspects, the request is included in a physical random access channel message.

In a thirteenth aspect, alone or in combination with one or more of the first through twelfth aspects, the request includes a preamble associated with the EH class.

In a fourteenth aspect, alone or in combination with one or more of the first through thirteenth aspects, the request is included in a PUSCH message associated with a random access procedure.

In a fifteenth aspect, alone or in combination with one or more of the first through fourteenth aspects, the request is indicated by a MAC control element included in the PUSCH message.

In a sixteenth aspect, alone or in combination with one or more of the first through fifteenth aspects, the MAC control element indicates the second SIB and the EH class.

In a seventeenth aspect, alone or in combination with one or more of the first through sixteenth aspects, process 800 includes transmitting a third SIB that is associated with another EH class that is different from the EH class, the third SIB including one or more parameters that match the second SIB.

In an eighteenth aspect, alone or in combination with one or more of the first through seventeenth aspects, the second SIB is included in a first SIB set of a plurality of SIB sets, each of the plurality of SIB sets corresponding to a respective EH class.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more other components.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive, from a network node, a first SIB that indicates an EH class supported by the network node. The reception component 902 may receive, from the network node and based at least in part on receiving the first SIB and the UE being associated with the EH class, a second SIB having one or more SIB characteristics that are based at least in part on the EH class.

The reception component 902 may receive at least one other SIB in a single transport block.

The transmission component 904 may transmit, to the network node, a request for the second SIB based at least in part on the first SIB indicating that the second SIB is available on-demand.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150 may include one or more other components.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The transmission component 1004 may transmit a first SIB that indicates an EH class supported by the network node. The transmission component 1004 may transmit a second SIB having one or more SIB characteristics that are based at least in part on the EH class.

The reception component 1002 may receive, from a UE, a request for the first SIB.

The reception component 1002 may receive, from a UE, a request for the second SIB.

The transmission component 1004 may transmit a third SIB that is associated with another EH class that is different from the EH class, the third SIB including one or more parameters that match the second SIB.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a UE, comprising: receiving, from a network node, a first SIB that indicates an energy harvesting capability class supported by the network node; and receiving, from the network node and based at least in part on receiving the first SIB and the UE being associated with the energy harvesting capability class, a second SIB having one or more SIB characteristics that are based at least in part on the energy harvesting capability class.
Aspect 2: The method of Aspect 1, wherein the one or more SIB characteristics comprise at least one of: the second SIB is transmitted via a plurality of transport blocks, the second SIB includes a parameter that is based at least in part on the energy harvesting capability class, or the second SIB includes, for a parameter, a parameter value that is based at least in part on the energy harvesting capability class.
Aspect 3: The method of any of Aspects 1-2, wherein the first SIB indicates one or more resources via which the second SIB is to be transmitted.
Aspect 4: The method of any of Aspects 1-3, wherein the energy harvesting capability class is associated with at least one of: a maximum number of communications with a full charge, a charging rate, or a duration to acquire the full charge.
Aspect 5: The method of any of Aspects 1-4, wherein the first SIB includes information identifying a plurality of different energy harvesting capability classes supported by the network node.
Aspect 6: The method of any of Aspects 1-5, wherein receiving the first SIB comprises: receiving a PBCH communication that includes a MIB and the first SIB; decoding the MIB to obtain one or more parameters for decoding the first SIB; and decoding the first SIB.
Aspect 7: The method of any of Aspects 1-6, wherein receiving the second SIB comprises: receiving the second SIB via a plurality of transport blocks.
Aspect 8: The method of Aspect 7, further comprising: receiving at least one other SIB in a single transport block.
Aspect 9: The method of any of Aspects 1-8, wherein the first SIB further indicates one or more resources in which one or more other SIBs are to be transmitted.
Aspect 10: The method of Aspect 9, wherein the first SIB further indicates that at least one of the second SIB, or at least one of the one or more other SIBs, are to be transmitted via a plurality of transport blocks.
Aspect 11: The method of any of Aspects 1-10, wherein the first SIB further indicates, for the energy harvesting capability class, which of a plurality of other SIBs are available on-demand.
Aspect 12: The method of Aspect 11, further comprising: transmitting, to the network node, a request for the second SIB based at least in part on the first SIB indicating that the second SIB is available on-demand.
Aspect 13: The method of Aspect 12, wherein the request is included in a physical random access channel message.
Aspect 14: The method of Aspect 13, wherein the request includes a preamble associated with the energy harvesting capability class.
Aspect 15: The method of Aspect 12, wherein the request is included in a PUSCH message associated with a random access procedure.
Aspect 16: The method of Aspect 15, wherein the request is indicated by a MAC control element included in the PUSCH message.
Aspect 17: The method of Aspect 16, wherein the MAC control element indicates the second SIB and the energy harvesting capability class.
Aspect 18: A method of wireless communication performed by a network node, comprising: transmitting a first SIB that indicates an energy harvesting capability class supported by the network node; and transmitting a second SIB having one or more SIB characteristics that are based at least in part on the energy harvesting capability class.
Aspect 19: The method of Aspect 18, wherein the one or more SIB characteristics comprise at least one of: the second SIB is transmitted via a plurality of transport blocks, the second SIB includes a parameter that is based at least in part on the energy harvesting capability class, or the second SIB includes, for a parameter, a parameter value that is based at least in part on the energy harvesting capability class.
Aspect 20: The method of any of Aspects 18-19, wherein the first SIB indicates one or more resources via which the second SIB is to be transmitted.
Aspect 21: The method of any of Aspects 18-20, wherein the energy harvesting capability class is associated with at least one of: a maximum number of communications with a full charge, a charging rate, or a duration to acquire the full charge.
Aspect 22: The method of any of Aspects 18-21, wherein the first SIB includes information identifying a plurality of different energy harvesting capability classes supported by the network node.
Aspect 23: The method of any of Aspects 18-22, wherein transmitting the first SIB comprises: transmitting a PBCH communication that includes a MIB and the first SIB.
Aspect 24: The method of any of Aspects 18-23, wherein transmitting the second SIB comprises: transmitting the second SIB via a plurality of transport blocks.
Aspect 25: The method of any of Aspects 18-24, wherein the first SIB further indicates one or more resources in which one or more other SIBs are to be transmitted.
Aspect 26: The method of Aspect 25, wherein the first SIB further indicates that at least one of the second SIB, or at least one of the one or more other SIBs, are to be transmitted via a plurality of transport blocks.
Aspect 27: The method of any of Aspects 18-26, wherein the first SIB further indicates, for the energy harvesting capability class, which of a plurality of other SIBs are available on-demand.
Aspect 28: The method of any of Aspects 18-27, further comprising: receiving, from a UE, a request for the first SIB; and wherein transmitting the first SIB comprises: transmitting the first SIB based at least in part on receiving the request. wherein transmitting the first SIB comprises: transmitting the first SIB based at least in part on receiving the request.
Aspect 29: The method of any of Aspects 18-28, further comprising: receiving, from a UE, a request for the second SIB; and wherein transmitting the second SIB comprises: transmitting the second SIB based at least in part on receiving the request. wherein transmitting the second SIB comprises: transmitting the second SIB based at least in part on receiving the request.
Aspect 30: The method of Aspect 29, wherein the request is included in a physical random access channel message.
Aspect 31: The method of Aspect 30, wherein the request includes a preamble associated with the energy harvesting capability class.
Aspect 32: The method of Aspect 29, wherein the request is included in a PUSCH message associated with a random access procedure.
Aspect 33: The method of Aspect 32, wherein the request is indicated by a MAC control element included in the PUSCH message.
Aspect 34: The method of Aspect 33, wherein the MAC control element indicates the second SIB and the energy harvesting capability class.
Aspect 35: The method of any of Aspects 18-34, further comprising: transmitting a third SIB that is associated with another energy harvesting capability class that is different from the energy harvesting capability class, the third SIB including one or more parameters that match the second SIB.
Aspect 36: The method of any of Aspects 18-35, wherein the second SIB is included in a first SIB set of a plurality of SIB sets, each of the plurality of SIB sets corresponding to a respective energy harvesting capability class.
Aspect 37: An apparatus for wireless communication at a device, comprising a processor; memory coupled with the processor; and instructions stored in the memory and executable by the processor to cause the apparatus to perform the method of one or more of Aspects 1-17.
Aspect 38: An apparatus for wireless communication at a device, comprising a processor; memory coupled with the processor; and instructions stored in the memory and executable by the processor to cause the apparatus to perform the method of one or more of Aspects 18-36.
Aspect 39: A device for wireless communication, comprising a memory and one or more processors coupled to the memory, the one or more processors configured to perform the method of one or more of Aspects 1-17.
Aspect 40: A device for wireless communication, comprising a memory and one or more processors coupled to the memory, the one or more processors configured to perform the method of one or more of Aspects 18-36.
Aspect 41: An apparatus for wireless communication, comprising at least one means for performing the method of one or more of Aspects 1-17.
Aspect 42: An apparatus for wireless communication, comprising at least one means for performing the method of one or more of Aspects 18-36.
Aspect 43: A non-transitory computer-readable medium storing code for wireless communication, the code comprising instructions executable by a processor to perform the method of one or more of Aspects 1-17.
Aspect 44: A non-transitory computer-readable medium storing code for wireless communication, the code comprising instructions executable by a processor to perform the method of one or more of Aspects 18-36.
Aspect 45: A non-transitory computer-readable medium storing a set of instructions for wireless communication, the set of instructions comprising one or more instructions that, when executed by one or more processors of a device, cause the device to perform the method of one or more of Aspects 1-17.
Aspect 46: A non-transitory computer-readable medium storing a set of instructions for wireless communication, the set of instructions comprising one or more instructions that, when executed by one or more processors of a device, cause the device to perform the method of one or more of Aspects 18-36.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors, coupled to the one or more memories, individually or collectively configured to cause the UE to:
receive, from a network node, a first system information block (SIB) that indicates an energy harvesting capability class supported by the network node; and
receive, from the network node and based at least in part on receiving the first SIB and the UE being associated with the energy harvesting capability class, a second SIB having one or more SIB characteristics that are based at least in part on the energy harvesting capability class.

2. The UE of claim 1, wherein the one or more SIB characteristics comprise at least one of:
the second SIB is transmitted via a plurality of transport blocks,
the second SIB includes a parameter that is based at least in part on the energy harvesting capability class, or
the second SIB includes, for a parameter, a parameter value that is based at least in part on the energy harvesting capability class.

3. The UE of claim 1, wherein the first SIB indicates one or more resources via which the second SIB is to be transmitted.

4. The UE of claim 1, wherein the energy harvesting capability class is associated with at least one of:
a maximum number of communications with a full charge,
a charging rate, or
a duration to acquire the full charge.

5. The UE of claim 1, wherein the first SIB includes information identifying a plurality of different energy harvesting capability classes supported by the network node.

6. The UE of claim 1, wherein the one or more processors, to cause the UE to receive the first SIB, are individually or collectively configured to cause the UE to:
receive a physical broadcast channel (PBCH) communication that includes a master information block (MIB) and the first SIB;
decode the MIB to obtain one or more parameters for decoding the first SIB; and
decode the first SIB.

7. The UE of claim 1, wherein the one or more processors, to cause the UE to receive the second SIB, are individually or collectively configured to cause the UE to:
receive the second SIB via a plurality of transport blocks.

8. The UE of claim 7, wherein the one or more processors are individually or collectively configured to cause the UE to:
receive at least one other SIB in a single transport block.

9. The UE of claim 1, wherein the first SIB further indicates one or more resources in which one or more other SIBs are to be transmitted.

10. The UE of claim 9, wherein the first SIB further indicates that at least one of the second SIB, or at least one of the one or more other SIBs, are to be transmitted via a plurality of transport blocks.

11. The UE of claim 1, wherein the first SIB further indicates, for the energy harvesting capability class, which of a plurality of other SIBs are available on-demand.

12. The UE of claim 11, wherein the one or more processors are individually or collectively configured to cause the UE to:
transmit, to the network node, a request for the second SIB based at least in part on the first SIB indicating that the second SIB is available on-demand.

13. The UE of claim 12, wherein the request is included in a physical random access channel message.

14. The UE of claim 13, wherein the request includes a preamble associated with the energy harvesting capability class.

15. The UE of claim 12, wherein the request is included in a physical uplink shared channel (PUSCH) message associated with a random access procedure.

16. The UE of claim 15, wherein the request is indicated by a medium access control (MAC) control element included in the PUSCH message.

17. The UE of claim 16, wherein the MAC control element indicates the second SIB and the energy harvesting capability class.

18. A network node for wireless communication, comprising:
one or more memories; and
one or more processors, coupled to the one or more memories, individually or collectively configured to cause the network node to:
transmit a first system information block (SIB) that indicates an energy harvesting capability class supported by the network node; and
transmit a second SIB having one or more SIB characteristics that are based at least in part on the energy harvesting capability class.

19. The network node of claim 18, wherein the one or more SIB characteristics comprise at least one of:
the second SIB is transmitted via a plurality of transport blocks,
the second SIB includes a parameter that is based at least in part on the energy harvesting capability class, or
the second SIB includes, for a parameter, a parameter value that is based at least in part on the energy harvesting capability class.

20-28. (canceled)

29. A method of wireless communication performed by a user equipment (UE), comprising:
receiving, from a network node, a first system information block (SIB) that indicates an energy harvesting capability class supported by the network node; and
receiving, from the network node and based at least in part on receiving the first SIB and the UE being associated with the energy harvesting capability class, a second SIB having one or more SIB characteristics that are based at least in part on the energy harvesting capability class.

30. (canceled)
